(19) United States
(12) Patent Application Publication
(10) Pub. No.: US 2019/0072955 A1
(43) Pub. Date: Mar. 7, 2019

(54) DRIVER ALERT SYSTEM FOR AN AUTOMATED VEHICLE

(71) Applicant: Delphi Technologies, Inc., Troy, MI (US)

(72) Inventors: Douglas L. Welk, Rossville, IN (US); Paul R. Martindale, Carmel, IN (US); Satish R, Bangalore (IN)

(21) Appl. No.: 15/695,552

(22) Filed: Sep. 5, 2017

(51) Int. Cl. G05D 1/00; B60W 50/14

(52) U.S. Cl. CPC G05D 1/0061; G05D 2201/0213; B60W 50/14

(57) ABSTRACT

A driver-alert system for an automated vehicle includes a display, and attention-detector, a hazard-detector, and a controller. The display is viewable by an operator of a host-vehicle. The attention-detector indicates when an operator is attentive to the display. The hazard-detector indicates when a hazard is present proximate to a travel-path of the host-vehicle. The controller is in communication with the attention-detector, the display, and the hazard-detector. The controller operates the display to warn the operator of the hazard only when the attention-detector indicates that the operator is attentive to the display.

### TECHNICAL FIELD OF INVENTION

This disclosure generally relates to a driver-alert system for an automated vehicle, and more particularly relates to a system that operates a display to warn the operator of the hazard only when an attention-detector indicates that the operator is attentive to the display.

### BACKGROUND OF INVENTION

It is known that an operator of a vehicle may become distracted so the operator is not always looking at the roadway ahead of the vehicle. The distraction may be due to the operator looking at a message on a phone operating the phone, adjusting an entertainment device in the vehicle, or viewing a display of the entertainment device.

### SUMMARY OF THE INVENTION

In accordance with one embodiment, a driver-alert system for an automated vehicle is provided. The system includes a display, and attention-detector, a hazard-detector, and a controller. The display is viewable by an operator of a host-vehicle. The attention-detector indicates when an operator is attentive to the display. The hazard-detector indicates when a hazard is present proximate to a travel-path of the host-vehicle. The controller is in communication with the attention-detector, the display, and the hazard-detector. The controller operates the display to warn the operator of the hazard only when the attention-detector indicates that the operator is attentive to the display.

Further features and advantages will appear more clearly on a reading of the following detailed description of the preferred embodiment, which is given by way of non-limiting example only and with reference to the accompanying drawings.

### BRIEF DESCRIPTION OF DRAWINGS

The present invention will now be described, by way of example with reference to the accompanying drawings, in which:

FIG. 1 is a diagram of a driver-alert system in accordance with one embodiment; and

FIG. 2 is an interior view of a vehicle equipped with the system of FIG. 1 in accordance with one embodiment.

### DETAILED DESCRIPTION

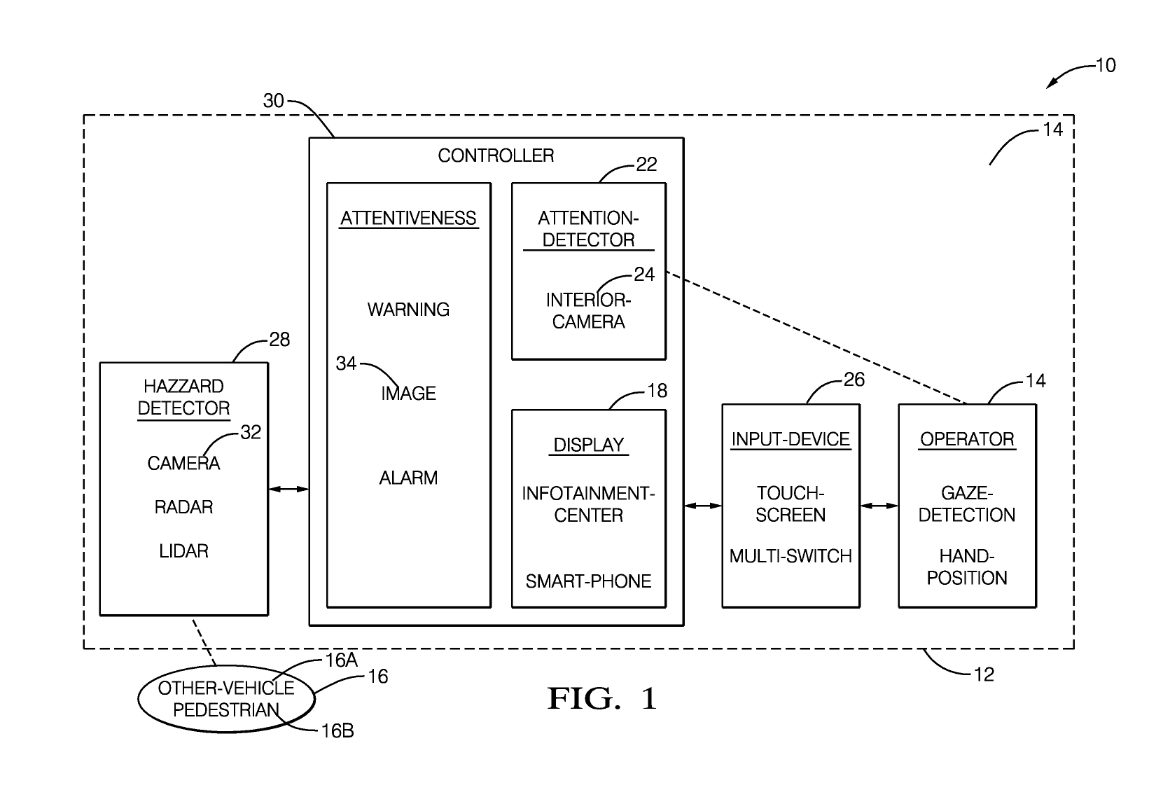

FIG. 1 illustrates a non-limiting example of a driver-alert system 10, hereafter referred to as the system 10, which may be installed in an automated vehicle, i.e. a host-vehicle 12. As used herein, the term automated vehicle may apply to instances when the host-vehicle 12 is being operated in an automated-mode, i.e. a fully autonomous mode, where an operator 14 of the host-vehicle 12 may do little more than designate a destination in order to operate the host-vehicle 12. However, full automation is not a requirement. It is contemplated that the teachings presented herein are useful when the host-vehicle 12 is operated in a manual-mode where the degree or level of automation may be little more than providing an audible or visual warning to the operator 14 who is generally in control of the steering, accelerator, and brakes of the host-vehicle 12. For example, the system 10 may merely assist the operator 14 as needed to avoid a collision with a hazard 16 such as, for example, an other-vehicle 16A or a pedestrian 16B in or proximate to the forward travel path of the host-vehicle 12. Other examples of instances of the hazard 16 include debris, snow/ice, or a tumbleweed on or moving toward the forward travel path of the host-vehicle 12.

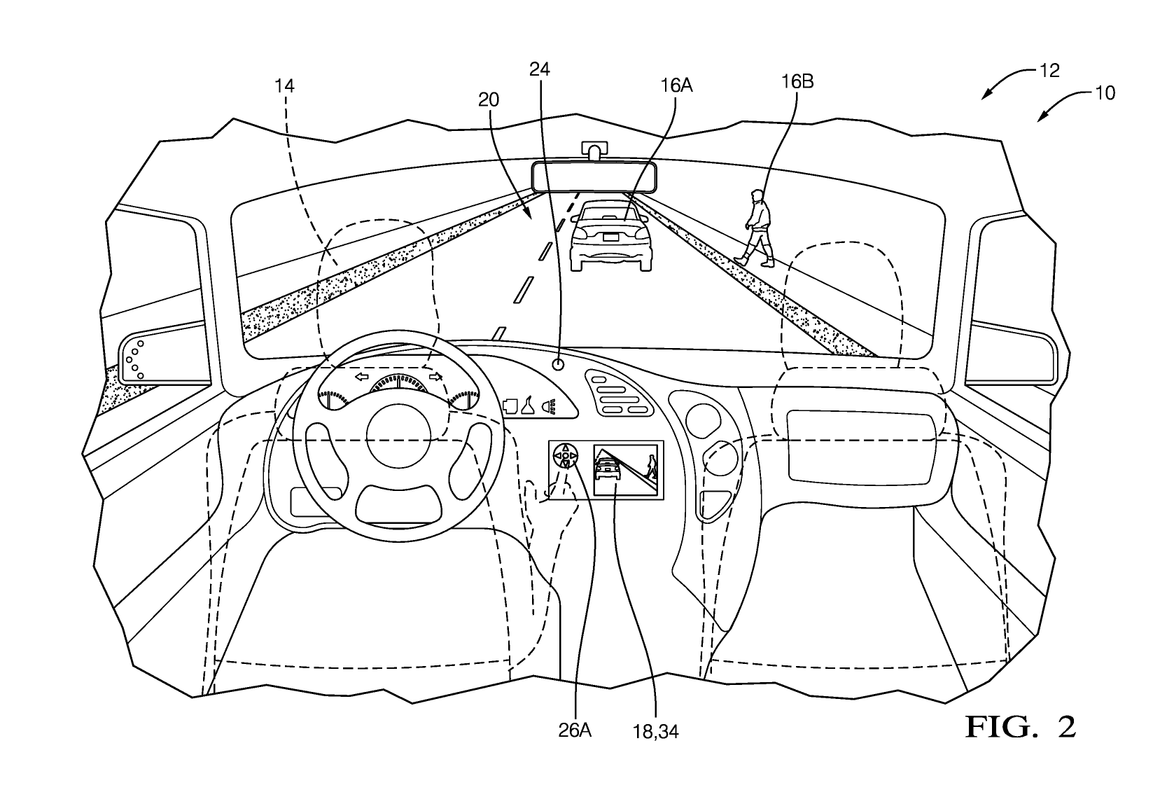

FIG. 2 illustrates a non-limiting example of an interior view of the host-vehicle 12 and instances of the other-vehicle 16A and the pedestrian 16B present in front of the host-vehicle 12. Continuing to refer to FIGS. 1 and 2, the system 10 includes a display 18 viewable by the operator 14 of the host-vehicle 12. The display 18 may be or may include, but is not limited to, a portable reconfigurable-display such as a smart-phone or tablet that is removable from the host-vehicle 12, a flat-panel type display that is part of an infotainment-center that displays navigation/entertainment information and is built into the host-vehicle 12, an instrument-cluster display that displays vehicle-status information, or any combination thereof. It has been observed that the operator 14 of the host-vehicle 12 may be distracted away from manually operating the host-vehicle 12 by looking at the display 18 rather than attentively viewing the roadway 20 (FIG. 2) ahead of the host-vehicle 12. As will be explained in more detail below, the system 10 described herein helps to avoid instances when the operator 14 may not detect in a timely manner an instance of the hazard 16 because the attention of the operator 14 is on the display 18.

It is contemplated that the teachings presented herein are useful in circumstances when the host-vehicle 12 is being manually driven by the operator 14 or the host-vehicle 12 is being autonomously operated, and the operator 14 needs to be alerted of the presence of the hazard 16. During autonomous operation, the attention of the operator 14 may need to be redirected as part of preparation for passing control of the host-vehicle 12 to the operator 14 because a situation has been encountered that the autonomous vehicle controls are unable to manage.

In order for the system 10 to determine where the attention of the operator 14 is directed, the system 10 includes an attention-detector 22 that indicates or is used to determine when an operator 14 is attentive to the display 18. The attention-detector 22 may be or may include, but is not limited to, an interior-camera 24 configured to have a field-of-view that may encompass the head, eyes, and/or hands of the operator 14. It is contemplated that the interior-camera 24 may be an infrared camera so an image of the operator 14 can be rendered at night. Techniques for processing images from the interior-camera 24 to determine, for example, a gaze-direction and/or a hand-position of the operator 14 are known. The attention-detector 22 may also be adapted to determine when an input-device 26 such as a touch-screen of one or more embodiments of the display 18 and/or a multi-switch 26A (FIG. 2) is being operated. That is, instead of or in addition to analyzing images from the interior-camera 24, the attention-detector 22 may be configured to detect when some sort of input by physical contact is being made to, for example, the infotainment-center, the smart-phone, the multi-switch, or some other embodiment of the input-device 26. The attention-detector 22 may also include other sensors such as infrared sensors (not shown) and/or ultrasonic transducers (not shown) configured to detect when the hand of the operator 14 is in close proximity to in instance of the input-device 26.

In order for the system 10 to determine when an instance of the hazard 16 is on or near the roadway 20 traveled by the host-vehicle 12, the system 10 includes a hazard-detector 28 that indicates when an instance of the hazard 16 is present proximate to a travel-path, e.g. the roadway 20, of the host-vehicle 12. The hazard-detector 28 may include or be formed by any one or combination of, but not limited to, a camera, a radar-unit, and/or a lidar-unit. The hazard-detector 28 may also include a transceiver (not shown) used for short range communication (e.g. DSRC or Dedicated Short Range Communications which is sometimes referred to as V2V or vehicle-to-vehicle communications) with other vehicles (including the other-vehicle 16A) on or near the roadway 20. The devices that make up or form the hazard-detector 28 preferably have a detection range sufficient for the system 10 to detect an instance of the hazard 16 at a distance that allows the operator 14 sufficient time to react, two-hundred-meters (200 m) for example.

The system 10 also includes a controller 30 in communication with the attention-detector 22, the display 18, and the hazard-detector 28. The communication may be by way of wires, optical-fiber, or wireless communications as will be recognized by those in the art. The controller 30 may include a processor (not specifically shown) such as a microprocessor or other control circuitry such as analog and/or digital control circuitry including an application specific integrated circuit (ASIC) for processing data as should be evident to those in the art. The controller 30 may include memory (not specifically shown), including non-volatile memory, such as electrically erasable programmable read-only memory (EEPROM) for storing one or more routines, thresholds, and captured data. The one or more routines may be executed by the processor to perform steps for determining when an instance of the hazard 16 exists and when the operator 14 is attentive to the display 18 based on signals received by the controller 30 as described herein.

While FIG. 1 could be interpreted to suggest that the attention-detector 22 and the display 18 are integrated into the controller, this is only to simplify the illustration and not intended to suggest a limitation on the configuration of the system 10. Indeed, multiple instances of the display 18 are contemplated that are remote from the parts that are typically key components of the controller 30, e.g. the processor and/or the memory. Similarly, that the input-device 26 is shown separate from the controller 30 is not intended to suggest a limitation on the configuration of the system 10. As will be explained in more detail below, the controller 30 is generally configured to determine the attentiveness of the operator 14, i.e. to what the operator 14 is attentive to, and when necessary issue a warning and/or display an image and/or sound an alarm to warn the operator of the presence of the hazard 16.

In order to overcome the aforementioned problem of the operator 14 being attentive to the display 18 when an instance of the hazard 16 is detected, i.e. when the operator 14 is distracted by the display 18, the controller 30 operates the display 18 to warn the operator 14 of the hazard 16 only when the attention-detector 22 indicates that the operator 14 is attentive to the display 18. That is, the system 10 does not take any action to affect what is on the display 18 if the operator is attentive to the roadway 20 because the operator 14 has likely detected the hazard 16. In the circumstance when the operator 14 is attentive to the roadway 20, i.e. the operator 14 is not distracted, it is advantageous that the system 10 does not affect what is on the display 18 as doing so could distract the operator 14 because the operator 14 may detect a sudden change in the contents of the display 18 via peripheral vision. However, if the operator 14 is attentive to the display 18 so the operator 14 is likely distracted from the roadway 20, and the system 10 detects an instance of the hazard 16, then the system 10 affects what is on the display 18 in an effort or attempt to refocus or redirect the attention of the operator 14 onto the roadway 20.

A variety of examples of what could be shown on the display 18 if/when the controller 30 operates the display 18 to warn the operator 14 are contemplated. One non-limiting embodiment of the system 10 includes a camera 32 that may be part of the hazard-detector 28. The camera 32 may be configured to render an image 34 of the hazard 16, and the controller 30 shows the image 34 on the display 18 (i.e. operates the display 18 to show the image on the display 18) when the controller 30 operates the display 18 to warn the operator 14. As discussed above, the system 10 would only show the image 34 on the display 18 if/when the operator 14 was attentive to (i.e. looking at) the display 18. If the operator 14 was attentive to the roadway 20, the system 10 would not make any changes to what was being shown on the display 18 that were related to the hazard 16. If the operator 14 were attentive to something other than the roadway 20 or the display 18, the system 10 may be further configured to take some other action, e.g. issue an audible message such as “hazard ahead.” However, no change to the display 18 would be made because the operator 14 was not attentive to the display 18.

As an alternative to the image 34, the display 18 may be operated to show a warning such as “hazard ahead” or “look up” or some other relevant message. In the aforementioned situation where the host-vehicle 12 was operating in an autonomous so the operator 14 was not engaged in the steering or braking of the host-vehicle, the display 18 may be operated to show a message such as “prepare for manual drive mode.”

Accordingly, a driver-alert system (the system 10), a controller 30 for the system 10, and a method of operating the system 10 is provided. The system 10 only operates the display to warn the operator 14 when the operator 14 is looking at the display. If the operator 14 is looking anywhere else other than the display, the system 10 does not use the display 18 to convey information to the operator 14.

While this invention has been described in terms of the preferred embodiments thereof, it is not intended to be so limited, but rather only to the extent set forth in the claims that follow.

We claim:

1. A driver-alert system for an automated vehicle, said system comprising:
a display viewable by an operator of a host-vehicle;
an attention-detector that indicates when an operator is attentive to the display;
a hazard-detector that indicates when a hazard is present proximate to a travel-path of the host-vehicle; and
a controller in communication with the attention-detector, the display, and the hazard-detector, wherein the controller operates the display to warn the operator of the hazard only when the attention-detector indicates that the operator is attentive to the display.

2. The system in accordance with claim 1, wherein the system includes a camera configured to render an image of the hazard, and the controller displays the image on the display when the controller operates the display to warn the operator.
